(19) United States
(12) Patent Application Publication
(10) Pub. No.: US 2016/0329074 A1
(43) Pub. Date: Nov. 10, 2016

(54) LUBRICANT LAYER ROBUST TO CONTAMINATION AND LUBRICANT SWELLING FOR USE IN MAGNETIC MEDIA AND METHODS OF MAKING THE SAME

(71) Applicant: HGST Netherlands B.V., Amsterdam (NL)

(72) Inventors: Thomas E. Karis, Aromas, CA (US); Bruno Marchon, Palo Alto, CA (US); Bala K. Pathem, Fremont, CA (US); Robert Waltman, Gilroy, CA (US)

(21) Appl. No.: 14/705,912

(22) Filed: May 6, 2015

(51) Int. Cl. G11B 5/84

(52) U.S. Cl. CPC G11B 5/84

(57) ABSTRACT

In one embodiment, a method includes forming a lubricant layer on an upper surface of a magnetic recording medium, the lubricant layer having a thickness greater than a dewetting thickness thereof, and polishing at least a portion of the upper surface of the magnetic recording medium using a polishing tape to remove any portion of the lubricant layer that extends above the dewetting thickness thereof, where, after the polishing, the resulting lubricant layer has a thickness about equal to the dewetting thickness thereof.

### FIELD OF THE INVENTION

The present invention relates to lubricants, and more particularly, this invention relates to lubricant layers robust to contamination and to lubricant swelling, which may be particularly useful for magnetic recording media.

### BACKGROUND

The heart of a computer is a magnetic hard disk drive (HDD) which typically includes a rotating magnetic disk, a slider that has read and write heads, a suspension arm above the rotating disk and an actuator arm that swings the suspension arm to place the read and/or write heads over selected data tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

The volume of information processing in the information age is increasing rapidly. In particular, HDDs have been desired to store more information in its limited area and volume. A technical approach to meet this desire is to increase the capacity by increasing the recording density of the HDD. To achieve higher recording density, further miniaturization of recording bits is effective, which in turn typically requires the design of smaller and smaller components. This reduction in component size is aided by the ability to maintain the reading and writing elements in a magnetic head in a position closer to the magnetic recording layer of the magnetic medium. This distance between the reading and writing elements and the magnetic recording layer is referred to as the magnetic spacing.

Narrowing the magnetic spacing is a very effective method for improving the recording density of a magnetic recording device, such as a HDD. Reducing the clearance, which is defined as the gap between the lowest point (farthest protruding portion at the ABS) of the magnetic head and the uppermost surface of the magnetic medium has been attempted to reduce the magnetic spacing. A technique used in magnetic recording devices to reduce this clearance relies on thermal expansion of one or more portions of the magnetic head. This thermal expansion is caused by a heater which is positioned near one or more elements of the magnetic head such that applying current to this heater controls the expansion of the one or more portions of the magnetic head to provide a smaller head-to-medium clearance.

However, a smaller clearance may also lead to undesirable interactions between the slider and a lubricant layer of the magnetic medium. Such slider-lubricant interactions may create moguls, ripples, depletions, etc. in the lubricant. Slider-lubricant interactions may also cause the lubricant to accumulate on the leading edge of the slider, thereby negatively affecting the performance of the read and write heads. Moreover, the lubricant accumulated on the leading edge of the slider may fall back onto the magnetic medium's surface, resulting in a lubricant layer having non-uniform thickness. Unfortunately, a non-uniform lubricant layer (e.g. a lubricant layer including moguls, ripples, thicker regions, etc.) may lead to errors during read and/or write operation, as well as allow scratching of the magnetic medium's surface in regions with little to no lubricant.

### SUMMARY

According to one embodiment, a method includes: forming a lubricant layer on an upper surface of a magnetic recording medium, the lubricant layer having a thickness greater than a dewetting thickness thereof; and polishing at least a portion of the upper surface of the magnetic recording medium using a polishing tape to remove any portion of the lubricant layer that extends above the dewetting thickness thereof, where, after the polishing, the resulting lubricant layer has a thickness about equal to the dewetting thickness thereof.

According to another embodiment, a system includes: a magnetic recording medium rotating in a circumferential direction thereof, the magnetic recording medium having a lubricant layer thereon; a polishing tape; a tape pressuring unit configured to press the polishing tape to an upper surface of the magnetic recording medium; and at least one drive mechanism configured to move the polishing tape in a radial direction on the upper surface of the magnetic recording medium to remove any portion of the lubricant layer that extends above a dewetting thickness thereof.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system, according to one embodiment.

FIG. 2A is a cross-sectional view of a perpendicular magnetic head with helical coils, according to one embodiment.

FIG. 2B is a cross-sectional view a piggyback magnetic head with helical coils, according to one embodiment.

FIG. 3A is a cross-sectional view of a perpendicular magnetic head with looped coils, according to one embodiment.

FIG. 3B is a cross-sectional view of a piggyback magnetic head with looped coils, according to one embodiment.

FIG. 4 is a schematic representation of a perpendicular recording medium, according to one embodiment.

FIG. 5A is a schematic representation of a recording head and the perpendicular recording medium of FIG. 4, according to one embodiment.

FIG. 5B is a schematic representation of a recording apparatus configured to record separately on both sides of a perpendicular recording medium, according to one embodiment.

FIG. 6 is a simplified representation of a magnetic recording medium, according to one embodiment.

FIG. 7A is a simplified representation of a lubricant molecule having one main chain segment and two attachment segments, according to one embodiment.

FIG. 7B is a representation of the molecular structure of Z-Tetraol.

FIG. 8A is a simplified representation of a lubricant molecule having two main chain segments and three attachment segments, according to one embodiment.

FIG. 8B is a representation of the molecular structure of ZTMD.

FIG. 9A is a simplified representation of lubricant molecule having three main chain segments and three attachment segments, according to one embodiment.

FIG. 9B is a representation of the molecular structure of 24TMD.

FIG. 9C is a representation of the molecular structure of 2TMD

FIG. 10A is a simplified representation of a lubricant layer having a thickness below its dewetting thickness, according to one embodiment.

FIG. 10B is a simplified representation of a lubricant layer having a thickness below its dewetting thickness, according to another embodiment.

FIG. 10C is a simplified representation of a lubricant layer having a thickness above its dewetting thickness, according to one embodiment.

FIG. 10D is a simplified representation of a lubricant layer having a thickness equal to its dewetting thickness, according to one embodiment.

FIG. 11 is a plot illustrating the relationship between lubricant layer thickness and the surface energetics thereof.

FIG. 12 is a plot illustrating the exposure time of a lubricant layer to a vapor lubricant versus the thickness of a lubricant layer after such exposure.

FIG. 13 is a plot of main chain molecular weight versus dewetting thickness.

FIG. 14A is a cross-sectional view of a system configured to remove dewetted layers of lubricant from the surface of a magnetic recording medium via a polishing process, according to one embodiment.

FIG. 14B is a top down view of the system shown in FIG. 14A.

FIG. 15 is a flowchart of a method, according to one embodiment.

FIG. 16 is a plot comparing lubricant layer thickness before and after implementation of a polishing process.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of disk-based storage systems and/or related systems and methods, as well as operation and/or component parts thereof.

In one general embodiment, a method includes: forming a lubricant layer on an upper surface of a magnetic recording medium, the lubricant layer having a thickness greater than a dewetting thickness thereof; and polishing at least a portion of the upper surface of the magnetic recording medium using a polishing tape to remove any portion of the lubricant layer that extends above the dewetting thickness thereof, where, after the polishing, the resulting lubricant layer has a thickness about equal to the dewetting thickness thereof.

In another general embodiment, a system includes: a magnetic recording medium rotating in a circumferential direction thereof, the magnetic recording medium having a lubricant layer thereon; a polishing tape; a tape pressuring unit configured to press the polishing tape to an upper surface of the magnetic recording medium; and at least one drive mechanism configured to move the polishing tape in a radial direction on the upper surface of the magnetic recording medium to remove any portion of the lubricant layer that extends above a dewetting thickness thereof.

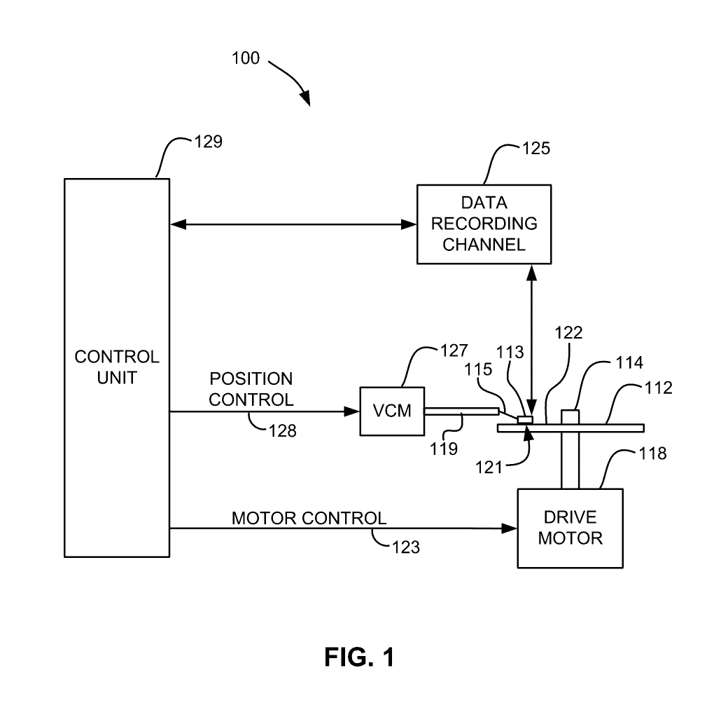

Referring now to FIG. 1, there is shown a disk drive 100 in accordance with one embodiment of the present invention. As shown in FIG. 1, at least one rotatable magnetic medium (e.g., magnetic disk) 112 is supported on a spindle 114 and rotated by a drive mechanism, which may include a disk drive motor 118. The magnetic recording on each disk is typically in the form of an annular pattern of concentric data tracks (not shown) on the disk 112. Thus, the disk drive motor 118 preferably passes the magnetic disk 112 over the magnetic read/write portions 121, described immediately below.

At least one slider 113 is positioned near the disk 112, each slider 113 supporting one or more magnetic read/write portions 121, e.g., of a magnetic head according to any of the approaches described and/or suggested herein. As the disk rotates, slider 113 is moved radially in and out over disk surface 122 so that portions 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by controller 129, such as access control signals and internal clock signals. Typically, control unit 129 comprises logic control circuits, storage (e.g., memory), and a microprocessor. In a preferred approach, the control unit 129 is electrically coupled (e.g., via wire, cable, line, etc.) to the one or more magnetic read/write portions 121, for controlling operation thereof. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write portions 121 by way of recording channel 125.

The above description of a magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will become apparent to one having skill in the art upon reading the present disclosure.

Regarding a magnetic head, an inductive write portion therein includes a coil layer embedded in one or more insulation layers (insulation stack), the insulation stack being located between first and second pole piece layers. A gap may be formed between the first and second pole piece layers by a gap layer at an air bearing surface (ABS) of the write portion. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in circular tracks on a rotating magnetic disk.

The second pole piece layer has a pole tip portion which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

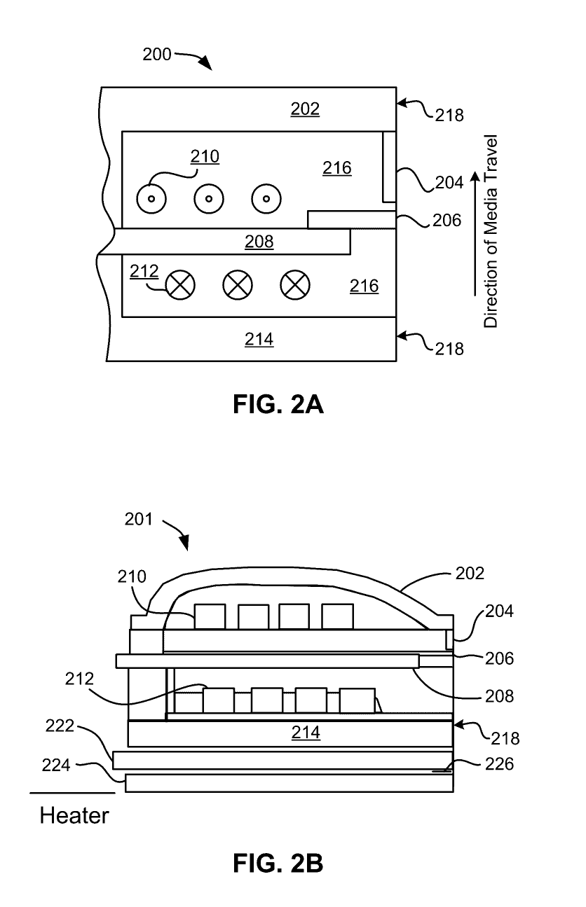

FIG. 2A is a cross-sectional view of a perpendicular magnetic head 200, according to one embodiment. In FIG. 2A, helical coils 210 and 212 are used to create magnetic flux in the stitch pole 208, which then delivers that flux to the main pole 206. Coils 210 indicate coils extending out from the page, while coils 212 indicate coils extending into the page. Stitch pole 208 may be recessed from the ABS 218. Insulation 216 surrounds the coils and may provide support for some of the elements. The direction of the media travel, as indicated by the arrow to the right of the structure, moves the media past the lower return pole 214 first, then past the stitch pole 208, main pole 206, trailing shield 204 which may be connected to the wrap around shield (not shown), and finally past the upper return pole 202. Each of these components may have a portion in contact with the ABS 218. The ABS 218 is indicated across the right side of the structure.

Perpendicular writing is achieved by forcing flux through the stitch pole 208 into the main pole 206 and then to the surface of the disk positioned towards the ABS 218.

FIG. 2B illustrates one embodiment of a piggyback magnetic head 201 having similar features to the head 200 of FIG. 2A. As shown in FIG. 2B, two shields 204, 214 flank the stitch pole 208 and main pole 206. Also sensor shields 222, 224 are shown. The sensor 226 is typically positioned between the sensor shields 222, 224.

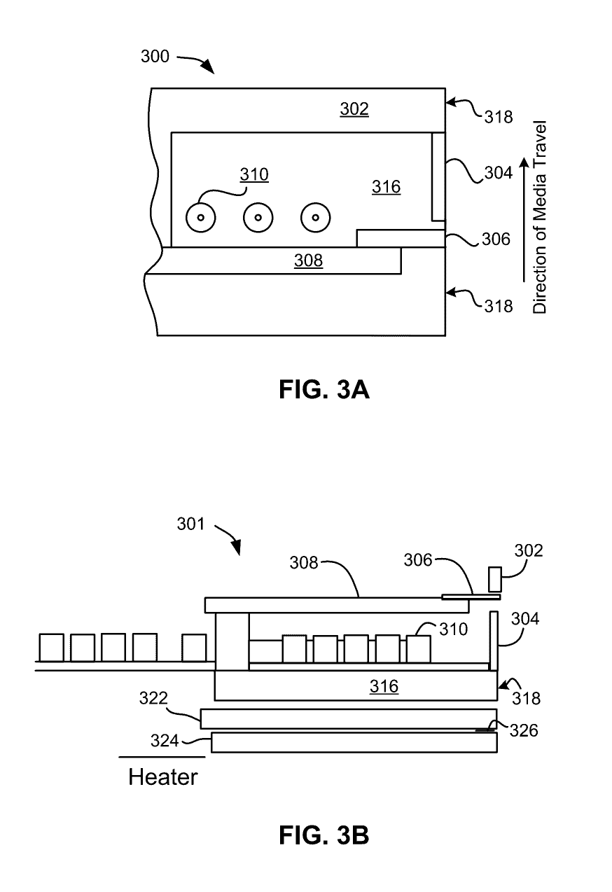

FIG. 3A is a schematic diagram of another embodiment of a perpendicular magnetic head 300, which uses looped coils 310 to provide flux to the stitch pole 308, a configuration that is sometimes referred to as a pancake configuration. The stitch pole 308 provides the flux to the main pole 306. With this arrangement, the lower return pole may be optional. Insulation 316 surrounds the coils 310, and may provide support for the stitch pole 308 and main pole 306. The stitch pole may be recessed from the ABS 318. The direction of the media travel, as indicated by the arrow to the right of the structure, moves the media past the stitch pole 308, main pole 306, trailing shield 304 which may be connected to the wrap around shield (not shown), and finally past the upper return pole 302 (all of which may or may not have a portion in contact with the ABS 318). The ABS 318 is indicated across the right side of the structure. The trailing shield 304 may be in contact with the main pole 306 in some embodiments.

FIG. 3B illustrates another embodiment of a piggyback magnetic head 301 having similar features to the head 300 of FIG. 3A. As shown in FIG. 3B, the piggyback magnetic head 301 also includes a looped coil 310, which wraps around to form a pancake coil. Sensor shields 322, 324 are additionally shown. The sensor 326 is typically positioned between the sensor shields 322, 324.

In FIGS. 2B and 3B, an optional heater is shown near the non-ABS side of the magnetic head. A heater (Heater) may also be included in the magnetic heads shown in FIGS. 2A and 3A. The position of this heater may vary based on design parameters such as where the protrusion is desired, coefficients of thermal expansion of the surrounding layers, etc.

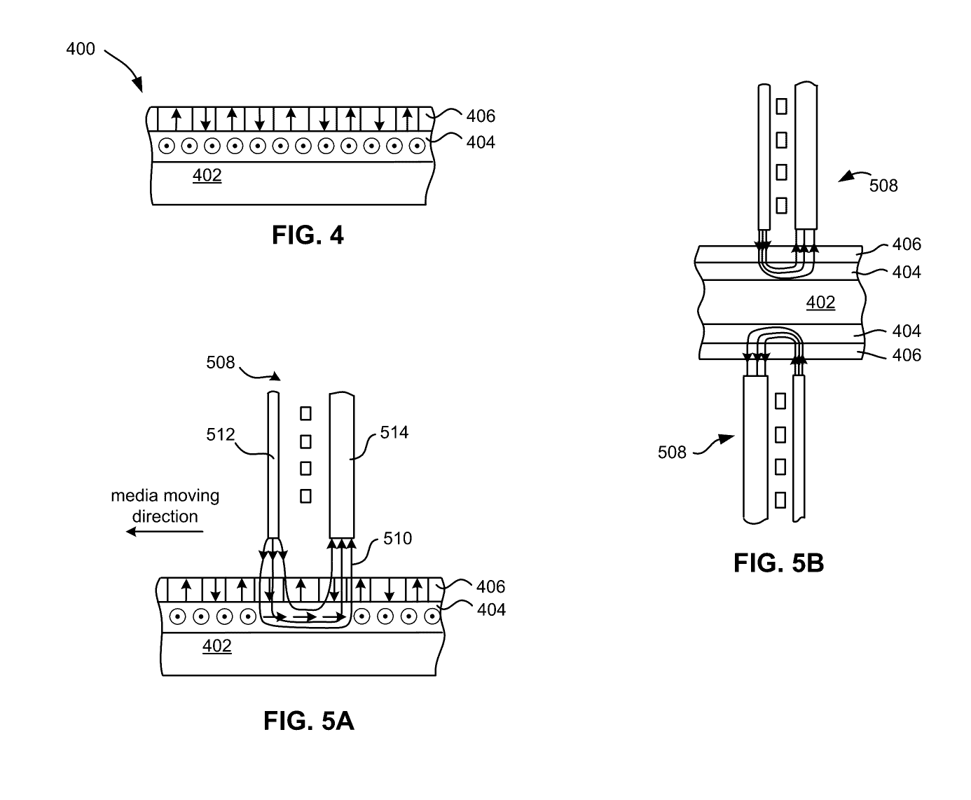

FIG. 4 provides a schematic diagram of a simplified perpendicular recording medium 400, which may also be used with magnetic disk recording systems, such as that shown in FIG. 1. As shown in FIG. 4, the perpendicular recording medium 400, which may be a recording disk in various approaches, comprises at least a supporting substrate 402 of a suitable non-magnetic material (e.g., glass, aluminum, etc.), and a soft magnetic underlayer 404 of a material having a high magnetic permeability positioned above the substrate 402. The perpendicular recording medium 400 also includes a magnetic recording layer 406 positioned above the soft magnetic underlayer 404, where the magnetic recording layer 406 preferably has a high coercivity relative to the soft magnetic underlayer 404. There may one or more additional layers (not shown), such as an “exchange-break” layer or “interlayer”, between the soft magnetic underlayer 404 and the magnetic recording layer 406.

The orientation of magnetic impulses in the magnetic recording layer 406 is substantially perpendicular to the surface of the recording layer. The magnetization of the soft magnetic underlayer 404 is oriented in (or parallel to) the plane of the soft underlayer 404. As particularly shown in FIG. 4, the in-plane magnetization of the soft magnetic underlayer 404 may be represented by an arrow extending into the paper.

FIG. 5A illustrates the operative relationship between a perpendicular head 508 and the perpendicular recording medium 400 of FIG. 4. As shown in FIG. 5A, the magnetic flux 510, which extends between the main pole 512 and return pole 514 of the perpendicular head 508, loops into and out of the magnetic recording layer 406 and soft magnetic underlayer 404. The soft magnetic underlayer 404 helps focus the magnetic flux 510 from the perpendicular head 508 into the magnetic recording layer 406 in a direction generally perpendicular to the surface of the magnetic medium. Accordingly, the intense magnetic field generated between the perpendicular head 508 and the soft magnetic underlayer 404, enables information to be recorded in the magnetic recording layer 406. The magnetic flux is further channeled by the soft magnetic underlayer 404 back to the return pole 514 of the head 508.

As noted above, the magnetization of the soft magnetic underlayer 404 is oriented in (parallel to) the plane of the soft magnetic underlayer 404, and may represented by an arrow extending into the paper. However, as shown in FIG. 5A, this in plane magnetization of the soft magnetic underlayer 404 may rotate in regions that are exposed to the magnetic flux 510.

FIG. 5B illustrates one embodiment of the structure shown in FIG. 5A, where soft magnetic underlayers 404 and magnetic recording layers 406 are positioned on opposite sides of the substrate 402, along with suitable recording heads 508 positioned adjacent the outer surface of the magnetic recording layers 406, thereby allowing recording on each side of the medium.

Except as otherwise described herein with reference to the various inventive embodiments, the various components of the structures of FIGS. 1-5B, and of other embodiments disclosed herein, may be of conventional material(s), design, and/or fabricated using conventional techniques, as would become apparent to one skilled in the art upon reading the present disclosure.

As discussed previously, lubricants may be used in various mechanical devices, including magnetic hard disk drives and other microeletronic mechanical systems. Lubricants may form a lubricant layer when one or more functional groups of the lubricant attach to the surface being lubricated. For instance, one or more lubricants may form a lubricant layer on a magnetic medium (e.g., a magnetic disk) that moves relative to other parts in the mechanic device. This lubricant layer may help to protect the magnetic medium from frictional wear and/or damage caused by interactions between the magnetic medium and other parts in the mechanical device (e.g., slider-magnetic medium interactions). In other words, this lubricant layer may help limit solid-to-solid contact.

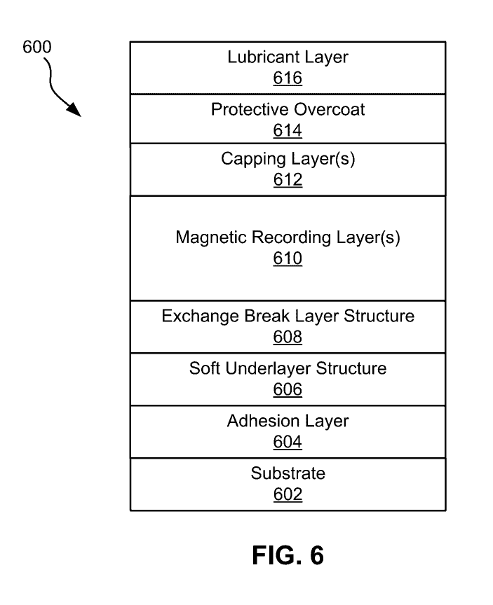

FIG. 6 illustrates a magnetic recording medium 600 having a lubricant layer, according to one embodiment. The magnetic recording medium 600 may be any type of magnetic media known in the art, such as a hard disk, a magnetic tape, an optical disk, etc. As an option, the magnetic recording medium 600 may be implemented in conjunction with features from any other embodiment listed herein, such as those described with reference to the other FIGS. Of course, the magnetic recording medium 600 and others presented herein may be used in various applications and/or in permutations which may or may not be specifically described in the illustrative embodiments listed herein. For instance, the magnetic recording medium 600 may include more or less layers than those shown in FIG. 6, in various approaches. Moreover, unless otherwise specified, formation of one or more of the layers shown in FIG. 6 may be achieved via atomic layer deposition (ALD), chemical vapor deposition (CVD), evaporation, e-beam evaporation, ion beam deposition, sputtering, or other deposition technique as would become apparent to a skilled artisan upon reading the present disclosure. Further, the magnetic recording medium 600 and others presented herein may be used in any desired environment.

As shown in FIG. 6, the magnetic recording medium 600 includes a substrate 602 comprising a material of high rigidity, such as glass, Al, Al₂O₃, AlMg, MgO, Si, or other suitable substrate material as would become apparent to one having skill in the art upon reading the present disclosure.

The magnetic recording medium 600 also includes an adhesion layer 604 formed above the substrate 602, the adhesion layer 604 being configured to improve adhesion between the substrate 602 and the layers formed thereon. In preferred approaches, the adhesion layer 604 comprises an amorphous material that does not affect the crystal orientation of the layers deposited thereon. Suitable materials for the adhesion layer 604 may include, but are not limited to, Ni, Co, Al, Ti, Cr, Zr, Ta, Nb and combinations and/or alloys thereof.

The magnetic recording medium 600 additionally includes a soft magnetic underlayer structure 606 formed above the adhesion layer 604. The soft magnetic underlayer structure 606 is configured to promote data recording in the magnetic recording layer(s) formed thereabove by suppressing the spread of the magnetic field and efficiently magnetizing the magnetic recording layer(s). In some approaches, the soft magnetic underlayer structure 606 may include a single layer structure or a multilayer structure. For instance, one example of a multilayer soft magnetic underlayer structure 606 may include a coupling layer (e.g., including at least one of Ru, Ir, Cr, etc.) sandwiched between one or more soft magnetic underlayers, where the coupling layer is configured to induce an anti-ferromagnetic coupling between the one or more soft magnetic underlayers.

In particular approaches, the soft magnetic underlayer(s) of the soft magnetic underlayer structure 606 may include a material having a high magnetic permeability. Suitable materials for the soft magnetic underlayer(s) thus include, but are not limited to, amorphous alloys including Co and/or Fe as the main component(s), with at least one of: Ta, Hf, Nb, Si, Zr, B, C, Cr, Ni, etc. added thereto. Illustrative examples of suitable materials for the soft magnetic underlayer(s) include CoNiFe, FeCoB, CoCuFe, NiFe, FeAlSi, FeTaN, FeN, FeTaC, CoTaZr, CoFeTa, CoFeTaZr, CoFeB, CoZrNb, etc.

As further shown in FIG. 6, the magnetic recording medium 600 includes an exchange break layer structure 608 formed above the soft magnetic underlayer structure 606. The exchange break layer structure 608 may be configured to magnetically decouple the magnetically permeable layers of the soft magnetic underlayer structure 606 and the magnetic recording layer(s). The exchange break layer structure 608 may also be configured to control the grain size and crystalline orientation of the layers formed thereabove.

In some approaches, the exchange break layer structure 608 may include a single layer structure or a multilayer structure. For example, in various approaches, the exchange break layer structure 608 may include at least one seed layer comprising Ni, Cu, Pd, Pt, Cr, W, V, Mo, Ta, Nb, Fe, and combinations thereof. In more approaches, the exchange break layer structure 608 may include one or more underlayers comprising materials having a hexagonal close packed (hcp) crystalline structure, such as Ru. In yet more approaches, the exchange break layer structure 608 may include at least one onset layer comprising Ru, Ti, Ta, B, Cr, Si, W, and/or oxides thereof.

One or more magnetic recording layers 610 are formed above the exchange break layer structure 608. The magnetic recording layer(s) 610 preferably each include a plurality of ferromagnetic grains separated from one another via a segregant material. The ferromagnetic material of the grains may include, but is not limited to, Cr, Fe, Ta, Ni, Mo, Pt, W, Cr, Ru, Ti, Si, O, V, Nb, Ge, B, Pd. In some approaches, the ferromagnetic grains may include alloys comprising Co and Pt as the main components. In more approaches, the segregant material may include at least one oxide and/or nitride of Si, Ti, Ta, B, Cr, W, Al, Mg, and Nb. In particular approaches, it may be possible to improve the overwrite characteristics while maintaining low noise by forming multiple magnetic recording layers where at least one, some or all of the magnetic recording layers have a different Co and/or Pt amount, a different amount of the added elements (e.g., Cr, Ti, Ta, Ru, W, Mo, Cu, B, Co, etc.), and/or a different amount of at least one oxide and/or nitride of Si, Ti, Ta, B, Cr, W and Nb.

As shown in FIG. 6, the magnetic recording medium 600 may include one or more optional capping layers 612 present above the magnetic recording layer(s) 610. The capping layer(s) 612 may be configured to mediate the intergranular coupling of the magnetic grains present in the magnetic recording layer(s) 610. In some approaches, the capping layer(s) 612 may include, for example, a Co—, CoCr—, CoPtCr—, and/or CoPtCrB— based alloy, or other material suitable for use in a capping layer as would be recognized by one having skill in the art upon reading the present disclosure. In more approaches, the capping layer(s) 612 may include at least one continuous capping layer (i.e., a capping layer without segregant materials included therein). In yet more approaches, the capping layer(s) 612 may include at least one granular capping layer, where any of the segregants disclosed herein may be included in said granular capping layer. In still more approaches, the capping layer(s) 612 may include a combination of at least one continuous capping layer and at least one granular capping layer.

The magnetic recording medium 600 may additionally include an optional protective overcoat layer 614 positioned above the one or more optional capping layers 612. The protective overcoat layer may be configured to protect the underlying layers from wear, corrosion, etc. This protective overcoat layer may be made of, for example, diamond-like carbon, carbon nitride, Si-nitride, BN or B4C, etc. or other such materials suitable for a protective overcoat as would become apparent to one having skill in the art upon reading the present disclosure.

As also shown in FIG. 6, the magnetic recording medium 600 includes a lubricant layer 616 positioned above the optional protective overcoat layer 614. The lubricant layer 616 includes one or more lubricants, each comprising at least one main chain segment and at least two attachment segments. A main chain segment may refer to a continuous segment/portion/part of a lubricant molecule that includes at least one perfluoropolyalkyl ether unit, according to various approaches. A main chain segment may also include, in addition to the at least one perfluoropolyalkyl ether unit, one or more fluoroalkyl ether units and/or one or more alkyl ether units, according to more approaches. An attachment segment may refer to a continuous segment/portion/part of the lubricant that includes at least one functional group configured to attach to a surface to be lubricated, according to yet more approaches. Suitable functional groups configured to attach to a surface to be lubricated may include, but are not limited to, a hydroxyl group, a piperonyl group, an amine group, a carboxylic acid, a phosphazene group, and combinations thereof.

In various approaches, each lubricant in the lubricant layer 616 may have an average MW in a range from about 1000 amu to about 6000 amu.

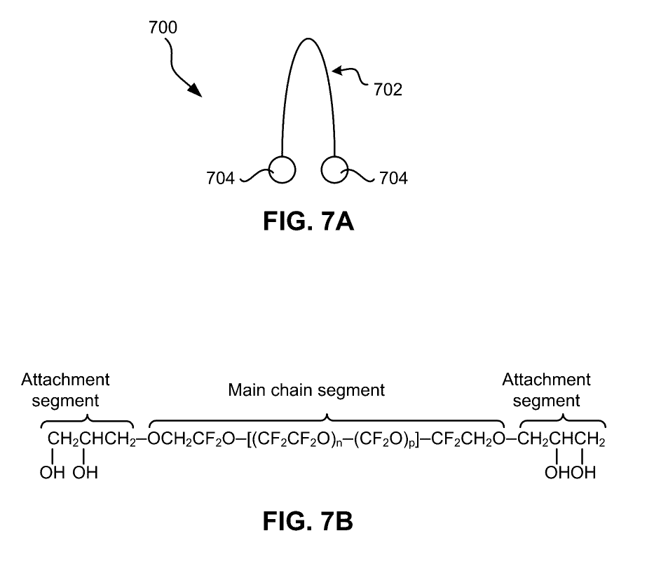

FIG. 7A illustrates an exemplary lubricant 700 suitable for use in the lubricant layer 616 of FIG. 6, according to one approach. As shown in FIG. 7A, the lubricant 700 includes a main chain segment 702, as well as attachment segments 704 positioned on either end of the main chain segment 702.

One example of a lubricant having the general structure shown in FIG. 7A is Z-Tetraol. The specific molecular structure of Z-Tetraol is illustrated in FIG. 7B, with annotations specifying the main chain and attachment segments. The “n” and “p” subscripts associated with the —(CF₂CF₂O)ₙ— and —(CF₂O)ₚ— units in the main chain segment shown in FIG. 7B each individually correspond to integers greater than zero.

Lubricants having the structure shown in FIG. 7A, such as Z-Tetraol, typically have a single, long, high molecular weight (MW) main chain segment. A high molecular weight may refer to a molecular weight greater than or equal to about 3000 amu, in various approaches. While a long, heavy main chain segment may be less prone to evaporation, it may create potential magnetic head-medium clearance issues. For example, a lubricant having a long, high MW main chain segment, which is tethered to a surface at both ends by attachment segments, has multiple degrees of freedom that may allow a portion (e.g., a middle portion) of the main chain segment to lift up from the surface and interact with a magnetic head positioned above. Unfortunately, merely decreasing the molecular weight of the single main chain segment to achieve an improved head-disk clearance margin may inevitably lead to evaporation issues, as molecular weight inversely and exponentially varies with vapor pressure. Likewise, merely decreasing the molecular weight of the single main chain segment may also decrease the effective viscosity of the lubricant, which has a linear, inverse relationship with molecular weight, leading to possible spin-off issues.

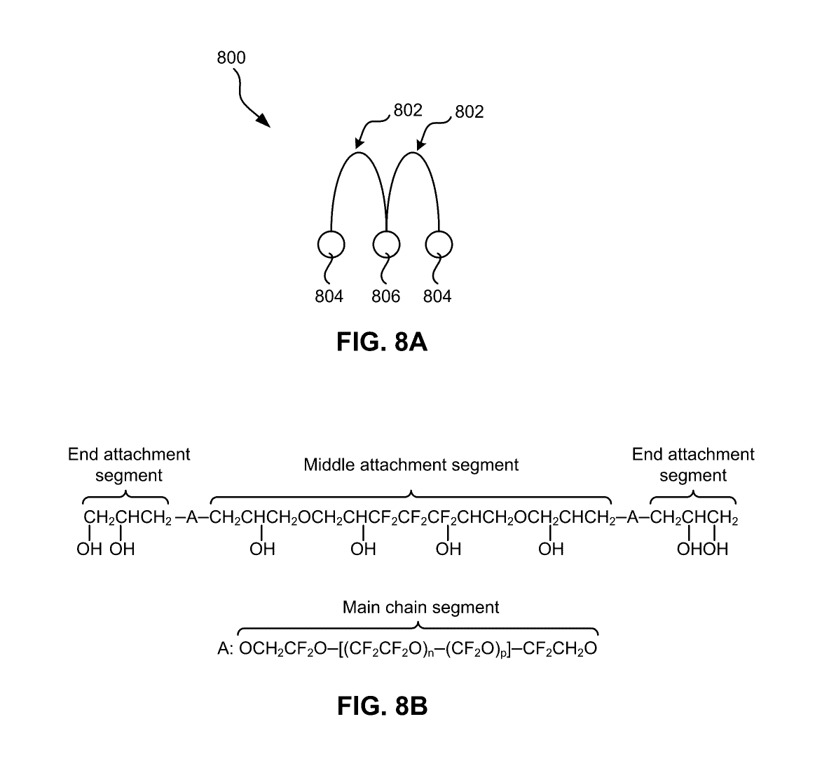

FIG. 8A illustrates another exemplary lubricant 800 suitable for use in the lubricant layer 616 of FIG. 6, according to one approach. As shown in FIG. 8A, the lubricant 800 includes two main chain segments 802, each of which may have the same or different molecular structure with respect to one another. The lubricant 800 also includes two end attachments segments 804, and a middle attachment segment 806, each of which may have the same or different molecular structure with respect to one another. Specifically, there is an end attachment segment 804 at one end of each main segment 802, and a middle attachment segment 806 at the other end of each main chain segment 802.

Each main chain segment in the lubricant 800 may be shorter and have a lower MW as compared to the single main chain segment of a lubricant having the structure shown in FIG. 7A. For example, in one approach, each main chain segment 802 in the lubricant 800 of FIG. 8A may have a MW that is approximately half of the MW of the main chain segment 702 of the lubricant 700 shown in FIG. 7A. Shorter and/or lighter main chain segments, tethered to a surface by end and/or middle attachment groups, may extend above the surface at a smaller height compared to a longer, heavier main chain segment, thereby improving the head-medium clearance margin. Moreover, reducing the potential for head-medium interactions using a lubricant having two shorter and/or lighter main chain segments (e.g., lubricant 800 of FIG. 8A) may not necessarily come at the expense of increasing evaporation issues. For instance, such a lubricant has two main chain segments and three attachment segments; thus, the overall MW of the lubricant may not be reduced to the point where evaporation is problematic.

One example of a lubricant having the structure shown in FIG. 8A is Z-Tetraol Multidentate (ZTMD). The molecular structure of ZTMD is illustrated in FIG. 8B, with annotations specifying the main chain and attachment segments. The “n” and “p” subscripts associated with the —(CF₂CF₂O)ₙ— and —(CF₂O)ₚ— units in the main chain segment shown in FIG. 8B each individually correspond to integers greater than zero.

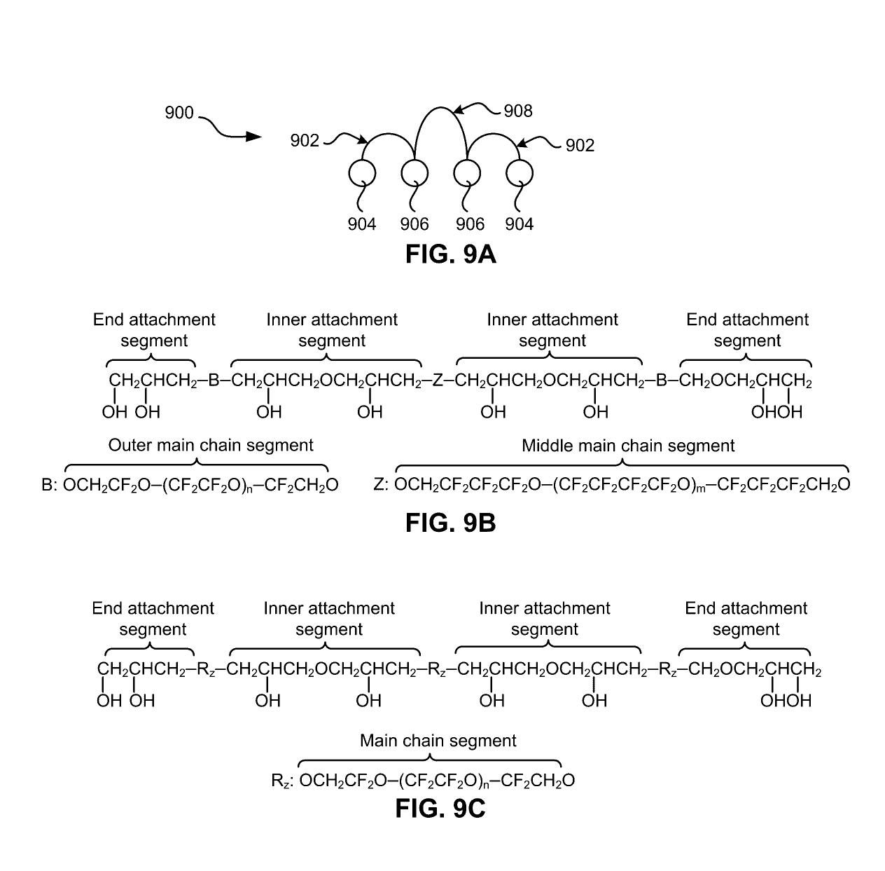

FIG. 9A illustrates yet another exemplary lubricant 900 suitable for use in the lubricant layer 616 of FIG. 6, according to one approach. As shown in FIG. 9A, the lubricant 900 includes two outer main chain segments 902, each of which have the same or different molecular structure with respect to one another. There is an end attachment segment 904 at one end of each outer main chain segment 902, and an inner attachment segment 906 at the other end of each outer main chain segment 902. In various approaches, the molecular structure of the end and inner attachment segments 904, 906 may be the same or different with respect to one another.

The lubricant also includes a middle main chain segment 908. This middle chain segment 908 has a molecular structure that may be the same or different from the two outer main chain segments 902. As illustrated in FIG. 9A, there are two inner attachment segments 906 positioned on either end of the middle main chain segment 908.

In numerous approaches, the MW of the main chain segments (e.g., the outer and/or middle main chain segments 902, 908) in the lubricant 900 may be shorter and/or have a lower MW as compared to the main chain segments of the lubricants shown in FIGS. 7A-B and 8A-B. Accordingly, in such approaches the potential for head-medium interaction may be further reduced using the lubricant 900 of FIG. 9A as compared to using the lubricants of FIGS. 7A-B and 8A-B. Furthermore, as the lubricant 900 of FIG. 9A has three main chain segments and four attachment segments; the overall MW of the lubricant may also not be reduced to the point where evaporation is problematic.

One example of a lubricant having the structure shown in FIG. 9A is 24TMD. The molecular structure of 24TMD is illustrated in FIG. 9B, with annotations specifying the main chain and attachment segments. As shown in FIG. 9B the end main chain segments of 24TMD each include at least one perfluorobutyl ether unit, —(CF₂CF₂O)ₙ—, where “n” is an integer greater than zero. The middle chain segment of 24TMD has a molecular structure that is different from the two outer main chain segments. For instance, as shown in FIG. 9B, the middle chain segment includes at least one perfluorobutyl ether unit, —(CF₂CF₂CF₂CF₂O)ₘ—, where “m” is an integer greater than zero.

Another example of a lubricant having the structure shown in FIG. 9A is 2TMD. The molecular structure of 2TMD is illustrated in FIG. 9C, with annotations specifying the main chain and attachment segments. Each of the main chain segments (i.e., the middle and two end chain segments) of 2TMD have the same molecular structure as one another. For instance, as shown in FIG. 9C, each of the main chain segments (R_{z}) include at least one perfluoroethyl ether unit, —(CF₂CF₂O)ₙ—, where “n” is an integer greater than zero. In various approaches, “n” may be two.

A lubricant having the molecular structure shown in FIG. 9C may have a lower CF₂ content as compared to 24TMD, which has a main chain segment with at least one perfluorobutyl ether unit. Accordingly, the lubricant of FIG. 9C may be less rigid and have better lubricity than 24TMD. Moreover, it is important to note that while the average MW of 2TMD's main chain segment may be lower than that for the other lubricants shown in FIGS. 7A-B, 8A-B, and 9A-9B, 2TMD does not necessarily suffer from increased evaporation issues. For instance, as noted above, 2TMD has three main chain segments and four attachment segments; thus, the overall MW of the lubricant may not be reduced at the expense of increasing vapor pressure (evaporation).

An additional example of a lubricant having the structure shown in FIG. 9A is 4TMD. 4TMD has a molecular structure similar to 2TMD with the exception that all of the main chain segments (i.e., the two end main chain segments and middle main chain segment) of 4TMD include at least one perfluorobutyl ether unit, —(CF₂CF₂CF₂CF₂O)ₘ—, where “m” is an integer greater than zero.

Referring again to FIG. 6, it is important to note that the lubricant layer 616 is not limited to the exemplary lubricants disclosed herein, e.g., Z-Tetraol, ZTMD, 24TMD, 2TMD, etc. For instance, the lubricant layer 616 may include other perfluoropolyether lubricants, fluorinated alcohols, fluorinated carboxylic acids, and other such suitable lubricants as would become apparent to one skilled in the art upon reading the present disclosure. Additional details and/or examples of suitable lubricants may be found in U.S. patent application Ser. No. 14/185,153, U.S. Pat. No. 8,518,564, U.S. Pat. No. 7,683,012, and U.S. Pat. No. 8,722,213, which are herein incorporated by reference in their entirety.

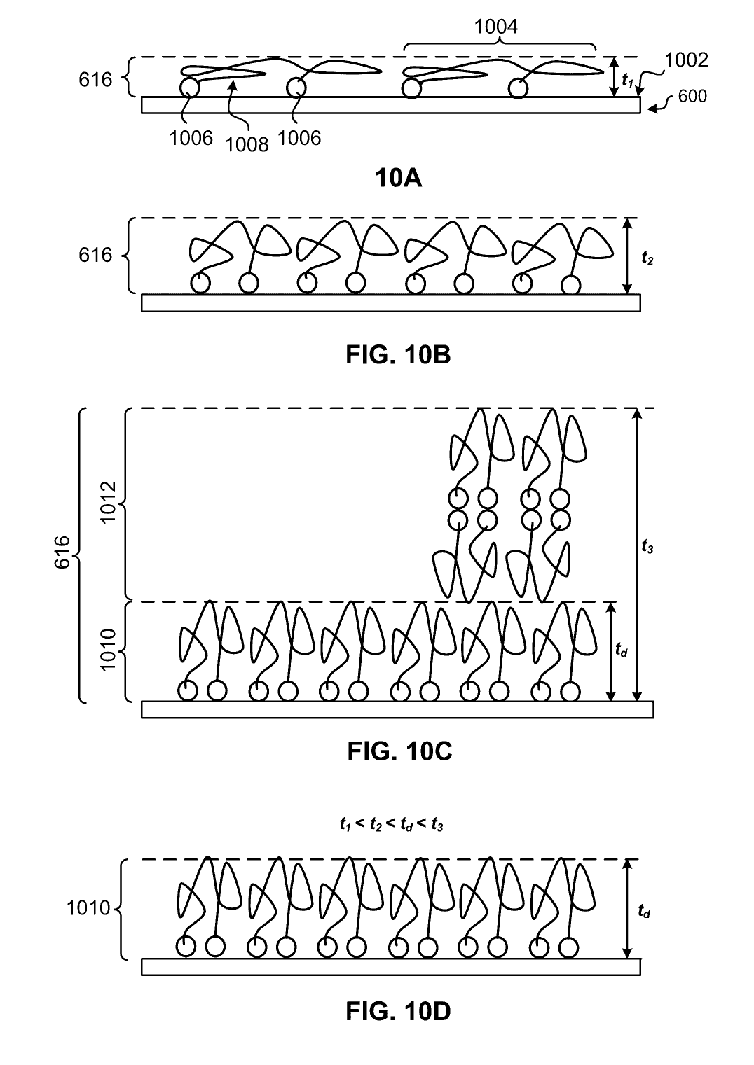

FIGS. 10A-10D illustrate four exemplary thicknesses of the lubricant layer 616 formed on an upper surface 1002 of the magnetic recording medium 600, according to various embodiments. As shown in FIGS. 10A-10D, the lubricant layer 616 includes lubricants 1004, each of which has two end attachment segments 1006 and a main chain segment 1008 positioned therebetween. It is again important to note that the lubricant layer 616 is not limited to lubricants 1004 having a single main chain segment 1008 and two end attachment segments 1006, rather such lubricants 1004 are shown in FIGS. 10A-10D for illustrative purposes only.

In embodiments where the lubricant layer 616 has a low lubricant concentration/amount (see e.g., FIG. 10A), the lubricants 1004 may be dispersed (spread out) to a greater extent than embodiments in which the lubricant layer 616 has a higher lubricant concentration/amount (see e.g.; FIG. 10B). For instance, as each lubricant 1004 has a flexible main chain segment 1008, increasing the lubricant concentration/amount in the lubricant layer 616 allows the lubricants 1004 to be more closely packed relative to one another. Moreover, as the lubricants 1004 become more closely packed, the main chain segments 1008 thereof will extend a greater height above the upper surface 1002 of the magnetic recording medium 600 (see e.g., FIG. 10B) compared to lubricants 1004 that are loosely packed (see e.g., FIG. 10A). Accordingly, the lubricant layer thickness, t₁, in FIG. 10A is less than the lubricant layer thickness, t₂, in FIG. 10B (t₁<t₂).

FIG. 10C illustrates an embodiment where the lubricant layer 616 has a large lubricant concentration/amount such that a monolayer 1010 and a first dewetted layer 1012 of lubricants is formed. As used herein in various approaches, a single monolayer of lubricants corresponds to a lubricant layer having an overall thickness that is equal to its dewetting thickness: (thickness of the lubricant layer)/(dewetting thickness of the lubricant layer)=1. This is shown in FIG. 10C by the lubricant monolayer 1010 that has a thickness, t_{d}, equal to its dewetting thickness. The dewetting thickness is the thickness of the layer above which dewetting occurs (i.e., instances where a solid or liquid film/layer on a surface retracts from the surface by forming discrete droplets or islands).

As the lubricant layer thickness approaches its dewetting thickness, the lubricants therein become more closely packed, thereby reducing the number of adsorption sites for contaminants (e.g., organic contaminates, hydrocarbon carbon contaminates, siloxane contaminates, etc.). Accordingly, in various approaches, the thickness of the lubricant layer 616, may be at least 70% of its dewetting thickness. In preferred approaches, the thickness of the lubricant layer 616 may be about equal to its dewetting thickness (e.g., as shown in FIG. 10D), thereby substantially eliminating contamination adsorption.

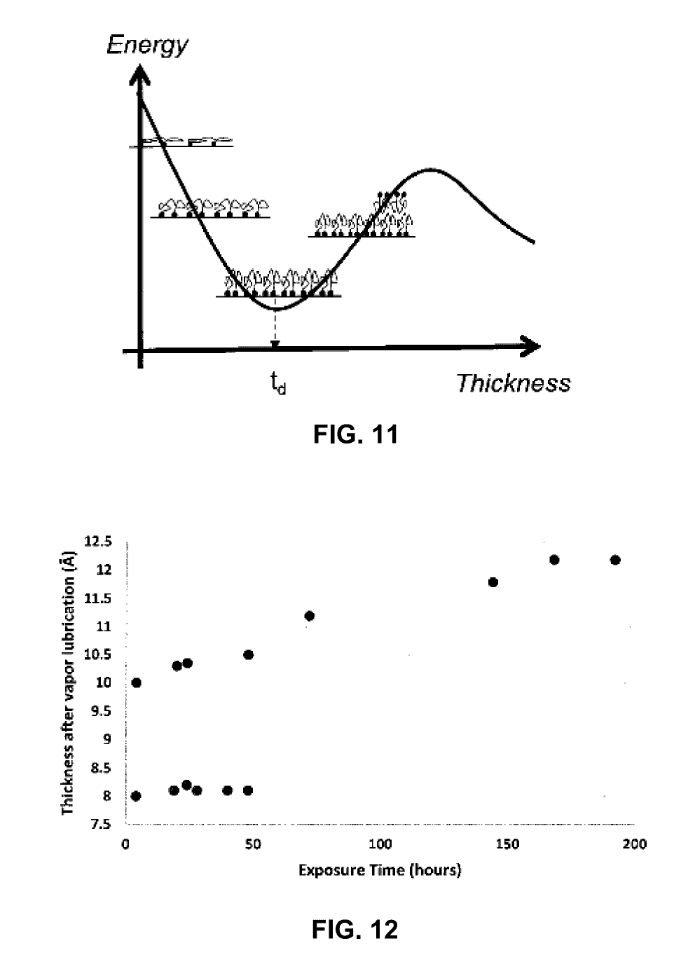

Operating at a lubricant layer thickness that approaches and/or is about equal to its dewetting thickness may also significantly reduce and/or eliminate swelling of the lubricant layer 616 in the presence of a vapor lubricant. Swelling of the lubricant layer 616 is a constant issue within magnetic recording systems that implement vapor lubricants. However, in approaches where the lubricant layer thickness approaches and/or is about equal to its dewetting thickness, the surface energetics provide no additional incentive for the adsorption of vapor lubricant, thereby reducing and/or eliminating the lubricant swelling issue, as shown in FIG. 11. The ability to reduce and/or eliminate lubricant swelling by tuning the lubricant layer thickness to approach its dewetting thickness may have particular applicability for heat assisted magnetic recording (HAMR) applications.

One non-limiting example illustrating the correspondence between lubricant layer thickness and lubricant layer swelling is provided in FIG. 12, which compares a magnetic recording disk coated with 10 Å of ZTMD (below its dewetting/monolayer thickness) and a magnetic recording disk coated with 8 Å of 2TMD (at its dewetting/monolayer thickness). Each of these disks were exposed to a PTMG vapor lubricant. As evident from FIG. 12, the magnetic recording disk having a ZTMD lubricant layer below its dewetting thickness exhibited an increase in its thickness (i.e., lubricant swelling) upon exposure to the vapor lubricant. In contrast, the magnetic recording disk having a 2TMD lubricant layer at its dewetting thickness did not exhibit an increase in its thickness upon exposure to the vapor lubricant.

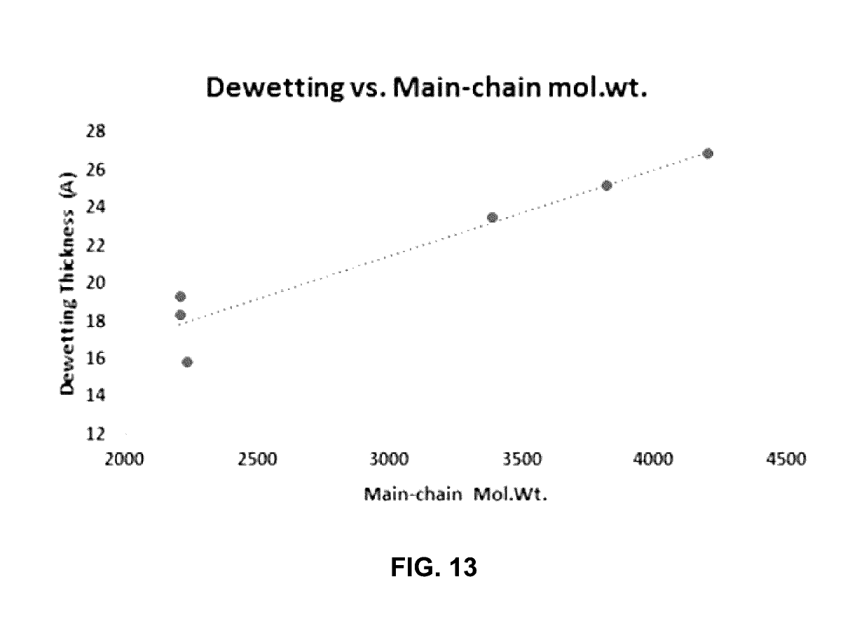

Referring now to FIG. 13, a plot of the average main chain molecular weight (amu) versus dewetting thickness (A) for a representative lubricant. The dewetting thickness of a lubricant is controlled by the molecular weight of its main chain segment(s) (e.g., its fluorocarbon backbone(s) and the degree of polymerization present therein). For example, the larger the average main chain molecular weight, the higher the dewetting thickness will be. Selection of lubricants with a low dewetting thickness (e.g., a dewetting thickness of 16 Å or less) is thus advantageous in minimizing head-medium spacing.

Typically, determining the dewetting thickness is a multi-step, time consuming and expensive analytical process that involves measurements of various magnetic recording media by Fourier Transform Infrared spectroscopy (FTIR), X-ray reflectivity (XRR), X-ray photoelectron spectroscopy (XPS), optical surface analysis (OSA), contact angle goniometer, and combinations thereof.

Various embodiments disclosed herein provide novel systems and methods for determining the dewetting thickness of a lubricant layer on magnetic recording media and/or fabricating magnetic recording media having a single lubricant monolayer thickness. To achieve a lubricant layer at its dewetting thickness (see e.g., FIG. 10D), these novel systems and methods may implement, in preferred approaches, a polish procedure including application of a thick lubricant layer on the upper surface of a magnetic recording medium, and removal of any additional lubricant layers (i.e., dewetted layers) present above the dewetting thickness using an absorbent polishing tape under a load of about 100 grams.

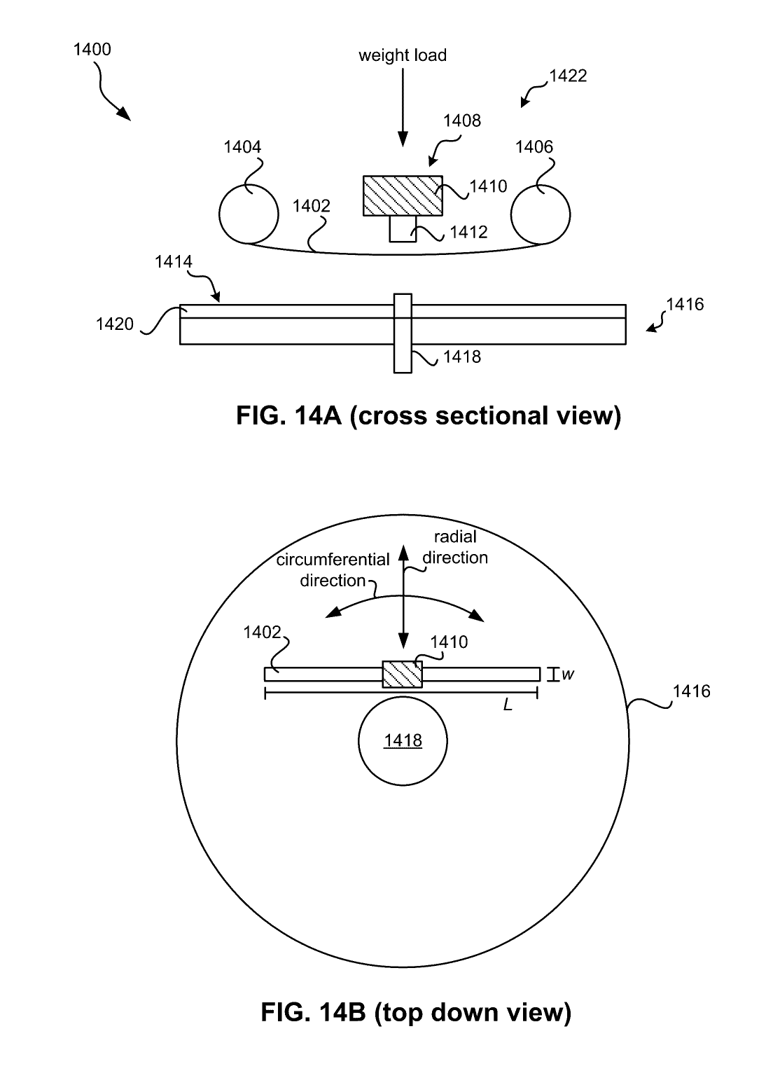

FIGS. 14A-14B illustrate a simplified representation of a system 1400 configured to remove dewetted layers of lubricant from the surface of a magnetic recording medium via a polishing process, according to one embodiment. The system 1400 may be implemented in conjunction with features from any other embodiment listed herein, such as those described with reference to the other FIGS. Of course, the system 1400 and others presented herein may be used in various applications and/or in permutations which may or may not be specifically described in the illustrative embodiments listed herein. Further, the system 1400 presented herein may be used in any desired environment, and/or include more or less components/features than those shown in FIG. 14A-14B.

As shown in FIG. 14A, the system 1400 includes a polishing apparatus 1422 comprising a polishing tape 1402, a tape supply cartridge 1404, a take-up reel 1406, and a tape pressuring unit 1408 including a pad mount 1410 and a pad 1412. The tape supply cartridge 1404 feeds the polishing tape 1402 wound around said cartridge. One or more guide rollers (not shown in FIG. 14A) may be present to guide the polishing tape 1402 fed from the tape supply cartridge 1404. The tape pressuring unit 1408 is configured to apply a predetermined weight load to the pad mount 1410 so as to allow the pad 1412 coupled thereto to contact the polishing tape 1402 and press said tape to the upper surface 1414 of the magnetic recording medium 1416 with a desired amount of pressing force. The magnetic recording medium 1416 (e.g., a magnetic recording disk) is supported on a spindle 1418 and rotated in a circumferential direction of the magnetic recording medium 1416. The take-up reel 1406 takes up the portion of the polishing tape 1402 that has performed the polishing process on at least one magnetic recording medium.

While not shown in FIG. 14A, the system 1400 may further include one or more drive motors (e.g., voice coil motors). In some approaches, at least one of the drive motors may be configured to drive the tape supply cartridge 1404 and the take-up reel 1406 to move the polishing tape 1402 there between. In more approaches, at least one of the drive motors may be configured to rotate the magnetic recording medium 1416. In yet more approaches, a servo motor may be configured to apply the predetermined weight load to the pad mount 1410.

The various components of the system 1400 may be controlled in operation by control signals generated by one or more controllers (not shown in FIG. 14A). The controller(s) may comprise logic control circuits, storage (e.g., memory to store instructions executable by the controller(s)), and a processor (e.g., a central processing unit (CPU), an application specific integrated circuit (ASIC), a field programmable gate array (FPGA), combinations thereof, etc.). In preferred approaches, the controller(s) may be electrically coupled (e.g., via wire, cable, line, etc.) to one or more components of the system 1400 for controlling operation thereof, where such components may include the drive motor(s) associated with the tape supply cartridge 1404, the take-up reel 1406, the tape pressuring unit 1408, the magnetic recording medium 1416, etc. Accordingly, the controller(s) may be configured to perform and/or be programmable to perform or control some or all of the methodology presented herein.

An interface (not shown in FIG. 14A) may also be provided for communication between the system 1400 and a host (integral or external) to send and/or receive data necessary for controlling the operation of one or more components of the system 1400, determining and/or communicating the status of the one or more components of the system 1400, etc., as would become apparent to one skilled in the art upon reading the present disclosure.

As noted above, the system 1400 is configured to implement a polishing process to ultimately yield a magnetic recording medium having a lubricant layer at its dewetting/monolayer thickness. Prior to this polishing process, a magnetic recording medium may typically have a lubricant layer whose overall thickness is greater than its dewetting thickness, such that the lubricant layer includes a monolayer and at least one dewetted layer of lubricant. To remove the at least one dewetted lubricant layer from the upper surface of this magnetic recording medium, the polishing tape 1402 is applied (e.g., pressed) to the surface of the magnetic recording medium under a predetermined weight load and moved radially from an inner periphery to an outer periphery (and/or from an outer periphery to an inner periphery) of the magnetic recording medium. While the polishing tape 1402 is moved radially, the magnetic recording medium is rotated in the circumferential direction, as shown in FIG. 14B.

The system 1400 may also be configured to advance the polishing tape 1402 to expose a new portion thereof. For instance, in various approaches, advancing the polishing tape 1402 may require the tape supply cartridge 1404 to feed a predetermined amount of the polishing tape 1402 wound around the cartridge, and the take-up reel 1406 to take up a corresponding amount of the polishing tape 1402 that has performed the polishing process on at least a portion of the magnetic recording medium 1416. In particular approaches, the polishing tape 1402 may be advanced such that some or all of the portion of the polishing tape 1402 that has performed the polishing process on at least a portion of the magnetic recording medium 1416 is taken up by the take-up reel 1406. In preferred approaches, the polishing tape 1402 may be advanced such that the entire portion of the polishing tape 1402 that has performed the polishing process on at least a portion of the magnetic recording medium 1416 is taken up by the take-up reel 1406.

In particular approaches, the same section of the polishing tape 1402 may be used to polish at least a portion of the magnetic recording medium 1416 prior to advancing the polishing tape 1402 to expose a new portion thereof. In preferred approaches, the same section of the polishing tape 1402 may be used to polish an entirety of the magnetic recording medium 1416 prior to advancing the polishing tape 1402 to expose a new portion thereof. In more approaches, the same section of the polishing tape 1402 may be used to polish one or more portions of one or more magnetic recording media prior to advancing the polishing tape 1402 to expose a new portion thereof.

In additional approaches, one or more conditions may trigger the advancement of the polishing tape 1402 in a longitudinal direction thereof. Examples of such triggering conditions may include, but are not limited to, the amount of a magnetic recording medium that has been polished, the number of magnetic recording media that have been polished, the expiration of a predetermined time period, instructions by a host or user, etc.

For instance, in one particular approach, the polishing tape 1402 may be advanced after a predetermined portion of a magnetic recording medium has been polished (e.g., after the polishing tape has made contact with and moved over the predetermined portion of the magnetic recording medium), where said predetermined portion may be: specified by a user, a host and/or the system 1400; based on past, present and/or future operating conditions, etc. In another approach, the polishing tape 1402 may be advanced after an entirety of a single magnetic recording medium has been polished. In yet another approach, the polishing tape 1402 may be advanced after a predetermined number of magnetic recording media have been polished (e.g., 1 magnetic recording medium, 2 magnetic recording media, 3 magnetic recording media, etc.), where said predetermined number of magnetic recording media may be: specified by a user, a host and/or the system 1400; based on past, present and/or future operating conditions, etc. In a further approach, the polishing tape 1402 may be advanced after a predetermined time period has elapsed, etc., where said predetermined time period may also be: specified by a user, a host and/or the system 1400; based on past, present and/or future operating conditions, etc. In an additional approach, the polishing tape 1402 may be advanced based on a request from a host or user.

In more approaches, the system 1400 may be configured to measure and/or monitor one or more characteristics of the polishing tape 1402, where such characteristics may include, but are not limited to, the amount of wear on the polishing tape, the amount of lubricant absorbed in the polishing tape, etc. In particular approaches, one or more of these characteristics may be measured and/or monitored by one or more sensors (not shown in FIGS. 14A-14B) operatively coupled to the system 1400. Moreover, in more approaches, advancement of the polishing tape 1402 may be based on one or more of these characteristics.

It is important to note that each advancement of the polishing tape 1402 need not be based on the same condition(s). It is also important to note that each advancement of the polishing tape 1402 may, but need not, advance the polishing tape 1402 the same amount.

With continued reference to FIG. 14, the polishing tape 1402 may include a cloth configured to absorb (e.g., via capillary pressure) the lubricant present in the lubricant layer 1420 of the magnetic recording medium 1416, particularly the lubricant present in any dewetted layers of said lubricant layer 1420. For example, as noted above, the magnetic recording medium 1416, prior to polishing, may have a lubricant layer 1420 whose overall thickness is greater than its dewetting thickness, such that the lubricant layer 1420 includes a lubricant monolayer and at least one dewetted lubricant layer. The lubricants in the monolayer are tightly bound to the surface of the magnetic recording medium 1416 via the attachment segments included in each lubricant. However, as the attachment segments of the lubricants do not have an affinity for fluorinated surfaces, the lubricants present in the dewetted layer(s) do not attach/bond to the fluorocarbon backbones of the lubricants in the monolayer present below. Accordingly, the lubricants in the dewetted layer(s) may form dimers (i.e., a pair of lubricants bound to each other via their respective attachment segments) that may be easily removed from the magnetic recording medium 1416 via absorption into the polishing tape 1402.

In various approaches, the system 1400 may be configured to remove the lubricant from one or more portions of the polishing tape 1402 by, for example, soaking the tape in solvents that are typically used in lubricant bath solutions, exposing the tape to solvent vapor to desorb the lubricant material, etc. Removal of the lubricant from one or more portions of the polishing tape 1402 may occur after a predetermined time period has elapsed, and/or based on one or more conditions (e.g., the amount of a magnetic recording medium that has been polished, the number of magnetic recording media that have been polished, instructions by a host or user, the amount of lubricant present on the polishing tape, etc.). Removal of the lubricant absorbed into the polishing tape 1402 in such instances may allow the same tape to be used for multiple polishing processes.

In some approaches, the polishing tape 1402 may include at least one of: cotton, nylon, polyester, and other such suitable material as would become apparent to one having skill in that art upon reading the present disclosure. In exemplary approaches, the polishing tape 1402 may include a nylon and/or polyester-based microfiber. In other approaches, the polishing tape 1402 may not include an abrasive material and/or abrasive grains. In further approaches, the material of the polishing tape 1402 may be selected based on the composition and/or characteristics of the lubricant layer 1420 of the magnetic recording medium 1416 so as to optimize absorption of any dewetted lubricant layers by the polishing tape 1402.

In more approaches, the thickness of the polishing tape 1402 may be in a range from about 1 to about 250 mm. In still more approaches, the width, w, of the polishing tape 1402 may be a range from about ¼ inch to about ½ inch. In preferred approaches, the width, w, of the polishing tape 1402 may be about ⅜ inches. In yet more approaches, the length, L, of the portion of the polishing tape 1402 that is exposed to the upper surface of the magnetic recording medium 1416 and suspended between the tape supply cartridge 1404 and the take-up reel 1406 may be in a range from about 3 mm to about 5 mm. In further approaches, one or more of the dimensions of the polishing tape 1402 may be selected to achieve optimal polishing conditions, selected based on the composition and/or characteristics of the lubricant layer 1420 on the magnetic recording medium 1416, etc.

As shown in FIG. 14A, the tape pressuring unit 1408 is configured to apply a predetermined weight load to the coupled pad mount 1410 and pad 1412 so as to press the polishing tape 1402 to the upper surface 1414 of the magnetic recording medium 1416 at a desired pressure. This predetermined weight load may be selected: by a user, a host, and/or the system 1400; based on past, present and/or future operating conditions; based on the composition and/or characteristics of the lubricant layer 1420 present on the magnetic recording medium 1416, etc. In some approaches, the predetermined weight load may be in a range between about 50 grams to about 150 grams. In one exemplary approach, the predetermined weight load may be about 100 grams.

In various approaches, the polishing tape 1402 may be pressed to the upper surface 1414 of the magnetic recording medium 1416 at a substantially constant pressure during the radial translation of the polishing tape. The amount and consistency of this pressure may be measured and/or monitored by one or more sensors (not shown in FIGS. 14A-14B) operatively coupled to the tape pressuring unit 1408.

The pad 1412 shown in FIG. 14A may include a foam material, such as polyurethane foam, in numerous approaches. In more approaches, the pad 1412 may have a material hardness in a range from about 15 durometer to about 30 durometer. In one particular approach, the pad 1412 may include a 17 durometer polyurethane foam. In more approaches, the pad 1412, similar to the polishing tape 1402, may include a material configured to absorb the lubricant present in any dewetted lubricant layers on the upper surface 1414 of the magnetic recording medium 1416.

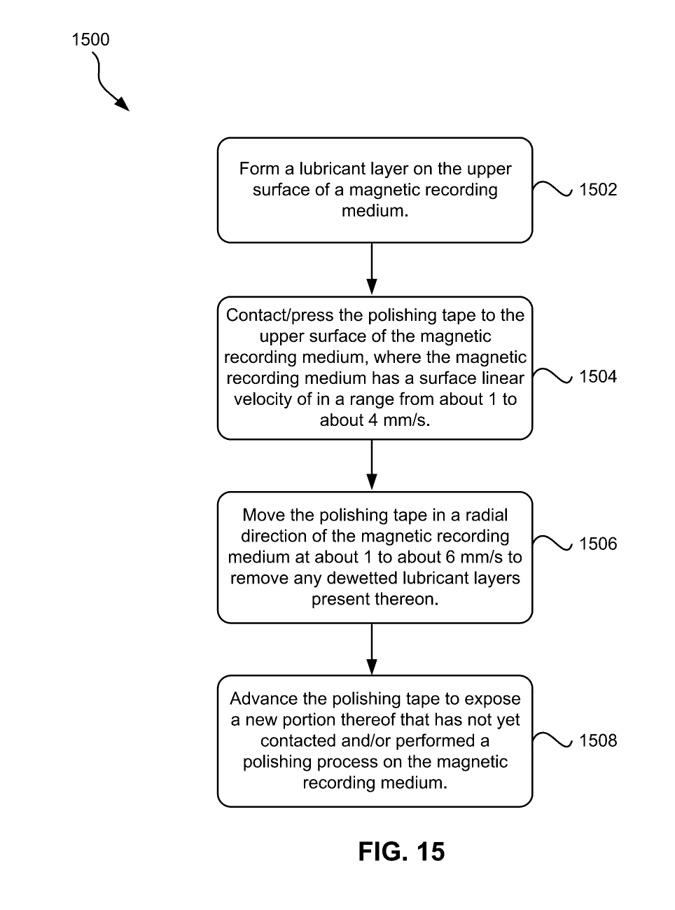

Referring now to FIG. 15, a method 1500 for forming a lubricant layer at its dewetting thickness is shown according to one embodiment. As an option, the method 1500 may be implemented to construct structures such as those shown in the other figures. Of course, this method 1500 and others presented herein may be used to form magnetic structures for a wide variety of devices and/or purposes which may or may not be related to magnetic recording. It should be noted that any aforementioned features may be used in any of the embodiments described in accordance with the various methods. It should also be noted that the method 1500 may include more or less steps than those described and/or illustrated in FIG. 15, according to various approaches. Further, the method 1500 and others presented herein may be carried out in any desired environment.

As shown in FIG. 15, the method 1500 includes forming a lubricant layer on the upper surface of a magnetic recording medium, such as a magnetic recording disk. See operation 1502. In various approaches, the magnetic recording medium may include a plurality of layers present below the lubricant layer, such as a substrate, an adhesion layer, a soft magnetic underlayer structure, an exchange break layer structure, one or more magnetic recording layers, one or more capping layers, a protective overcoat layer, etc. In particular approaches, the lubricant layer may be applied to the upper surface of a protective overcoat layer present on the magnetic recording medium.

In some approaches, the lubricant layer may include at least one lubricant having at least one main chain segment and at least two end attachment segments. The main chain segment preferably includes at least one perfluoropolyalkyl ether unit, and the end attachment segments each preferably include at least one functional group (e.g., a hydroxyl group, a piperonyl group, an amine group, a carboxylic acid, a phosphazene group, combinations thereof, etc.) configured to attach to a surface to be lubricated. In various approaches, the at least one lubricant may include Z-Tetraol, ZTMD, 24TMD, 2TMD, 4TMD, PTMG, Z-Dol, combinations thereof, and other suitable lubricants as would become apparent to one having skill in the art upon reading the present disclosure.

In one particular approach, the lubricant layer may be formed on the magnetic recording medium via a dip coating method. For instance, in one such approach, the magnetic recording medium having a protective overcoat thereon may be dipped into a lubricant bath including a desired lubricant (e.g., a multidentate perfluoropolyether lubricant) and a fluorocarbon solvent such as Vertrel-XF. After a predetermined amount of time, the magnetic recording medium may be removed from the lubricant bath at a controlled rate. The solvent may then evaporate, leaving behind the lubricant layer comprising the lubricant. The thickness of the lubricant layer may be tuned by controlling the submergence duration of the magnetic recording medium in the lubricant bath, the rate at which the magnetic recording medium is removed from the coating solution, and/or the concentration of the lubricant (e.g., the multidentate perfluoropolyether lubricant) in the lubricant bath.

Formation of the lubricant layer on the surface of the magnetic medium is not limited to dip coating, but may also involve spin coating, spray coating, a vapor deposition, combinations thereof, or any other suitable coating/deposition process as would become apparent to one having skill in the art upon reading the present disclosure.

In various approaches, formation of the lubricant layer in operation 1502 results in a lubricant layer having a thickness greater than its dewetting thickness. Accordingly, formation of the lubricant layer in such approaches results in formation of a single lubricant monolayer and one or more dewetted lubricant layers.

The method 1500 further includes application of a tape polishing process to the magnetic recording medium to remove dewetted lubricant layers present thereon. Application of this tape polishing process ultimately forms a magnetic recording layer having a single lubricant monolayer at its dewetting thickness. As shown in FIG. 15, this tape polishing process may include contacting/pressing a polishing tape to the upper surface of the magnetic recording medium. See operation 1504. In a particular approach, the tape polishing process may include contacting/pressing a polishing tape to the upper surface of the magnetic recording medium, where the magnetic recording medium has a surface linear velocity in a range from about 1 to about 4 mm/s.

In various approaches, contacting/pressing the polishing tape to the upper surface of the magnetic recording medium may include applying a predetermined weight load to the polishing tape so as to press the tape to the upper surface of said medium at a desired pressure. In one particular approach, this predetermined weight load may be applied to a polishing pad positioned above the polishing tape such that the pad contacts and presses the polishing tap to the upper surface of the magnetic recording medium at the desired pressure. This predetermined weight load may be selected: by a user, a host and/or a system configured to implement the method 1500; based on past, present and/or future operating conditions; based on the composition and/or characteristics of the lubricant layer present on the magnetic recording medium, etc. In some approaches, the predetermined weight load may be in a range between about 50 grams to about 150 grams. In one exemplary approach, the predetermined weight load may be about 100 grams.

In various approaches, the polishing tape may include a cloth configured to absorb (e.g., via capillary osmotic pressure) the lubricant present in any dewetted lubricant layers present on the magnetic recording medium. For instance, in exemplary approaches, the polishing tape may include at least one of: cotton, nylon, polyester, and other such suitable material as would become apparent to one having skill in that art upon reading the present disclosure. In particular approaches, the polishing tape may include a nylon and/or polyester-based microfiber. In other approaches, the polishing tape may not include an abrasive material and/or abrasive grains. In further approaches, the material of the polishing tape may be selected based on the composition and/or characteristics of the lubricant layer of the magnetic recording medium.

The polishing tape may have a thickness in a range from about 1 mm to about 2 mm, according to more approaches. In additional approaches, the polishing tape may have a width in a range from about ¼ inch to about ½ inch. In further approaches, the length of the portion of the polishing tape exposed to the upper surface of the magnetic recording medium may be in a range from about 3 mm to about 5 mm. In further approaches, one or more of the dimensions of the polishing tape may be selected to achieve optimal polishing conditions, selected based on the composition and/or characteristics of the lubricant layer on the magnetic recording medium, etc.

In preferred approaches, the polishing tape may be a component in a polishing apparatus, such as the polishing apparatus 1422 shown in FIG. 14A.

With continued reference to FIG. 15, the method 1500 also includes moving the polishing tape in a radial direction on the magnetic recording medium to remove any portion of its lubricant layer that extends above its dewetting thickness. See operation 1506. In preferred approaches, the polishing tape may be moved in a radial direction from an inner periphery of the magnetic recording medium to an outer periphery of the magnetic recording medium, and/or vice versa. In yet more preferred approaches, the polishing tape may be moved in a radial direction at a speed ranging from about 1 to about 6 mm/s on the magnetic recording medium. In additional approaches, the polishing tape may be moved in a radial direction while the magnetic recording medium is rotating in a circumferential direction. Such movement of the polishing tape on the rotating magnetic medium, e.g., moving the polishing tape in a radial direction from an inner periphery of the medium to an outer periphery thereof, effectively polishes an entirety of the upper surface of said medium and removes any dewetted lubricant layers present thereon.

As further shown in FIG. 15, the method 1500 includes advancing the polishing tape (e.g., in a longitudinal direction thereof) to expose a portion of the polishing tape that has not yet contacted and/or performed a polishing process on the magnetic recording medium. Such advancement of the polishing tape also removes a portion of the polishing tape that has already contacted and/or polished a portion of the magnetic recording medium. See operation 1508. In various approaches, the polishing tape may be advanced such that some or all of the portion of the polishing tape that has performed the polishing process on at least a portion of a magnetic recording medium is removed (e.g., by being taken up by a take-up reel such as that shown in FIG. 14) and no longer subject to a further polishing process. In a preferred approach, the polishing tape may be advanced such that the entire portion of the polishing tape that has performed the polishing process on at least a portion of a magnetic recording medium is removed and no longer subject to a further polishing process.

In particular approaches, the same section of the polishing tape may be used to polish at least a portion of the magnetic recording medium prior to advancing the polishing tape to expose a new portion thereof. In one approach, an entirety of the magnetic medium may be polished using the same section of the polishing tape prior to advancing the tape to expose a new portion thereof. In another approach, the same section of the polishing tape may be used to polish one or more portions of at least two magnetic recording media prior to advancing the polishing tape to expose a new portion thereof.

In additional approaches, the method 1500 may include advancing the tape in a longitudinal direction thereof based on the occurrence of one or more triggering conditions. For instance, in one approach, the polishing tape may be advanced after a predetermined portion of the medium has been polished (e.g., after the polishing tape has made contact with and been moved over a predetermined portion of the magnetic recording medium), where said predetermined portion may be specified: by a user, a host and/or a system configured to implement the method in whole or in part; based on past, present and/or future operating conditions, etc. In another approach, the polishing tape may be advanced after an entirety of a single magnetic recording medium has been polished. In yet another approach, the polishing tape may be advanced after a predetermined number of magnetic recording media have been polished (e.g., 1 magnetic recording medium, 2 magnetic recording media, 3 magnetic recording media, etc.), where said predetermined number of magnetic recording media may be specified: by a user, a host and/or a system configured to implement the method in whole or in part; based on past, present and/or future operating conditions, etc. In still another approach, the polishing tape may be advanced after a predetermined time period has elapsed, etc., where said predetermined time period may also be specified: by a user, a host and/or a system configured to implement the method in whole or in part; based on past, present and/or future operating conditions, etc. In an additional approach, the polishing tape may be advanced based on a request from host or user.

In more approaches, the method 1500 may include monitoring and/or measuring one or more characteristics of the polishing tape, where such characteristics may include, but are not limited to, the amount of wear on the polishing tape, the amount of lubricant absorbed in the polishing tape, etc. In yet more approaches, the method 1500 may additionally include advancing the polishing tape based on one or more of these characteristics. For instance, in one exemplary approach, the polishing tape may be advance when an amount of lubricant absorbed therein equals or exceeds a threshold value. The measurement and/or monitoring of these characteristics may be performed via one or more sensors present in the vicinity of and/or operatively coupled to the polishing tape.

It is also important to note that each advancement of the polishing tape may, but need not, advance the polishing tape the same amount. Likewise, each advancement of the polishing tape may, but need not be, based on the same condition(s).

The method 1500 provides a novel means by which determine the dewetting thickness of a lubricant layer on a magnetic recording medium, as well as form a lubricant monolayer at its dewetting thickness on a magnetic recording medium. Moreover, implementation of the method 1500 may achieve such results in less time and/or at considerably less expense than conventional methods used to determine the dewetting thickness of a lubricant layer. For instance, in various approaches, the method 1500 may be used to polish a magnetic recording medium, remove any dewetted lubricant layers therefrom and thereby forming a single lubricant monolayer at its dewetting thickness in one day or less, preferably in about 1 to about 6 hours.

Additionally, it is of note that the polishing process embodied in method 1500 differs from conventional burnishing processes used to remove asperities from the upper surface of magnetic recording media. For instance, in various approaches, the polishing tape used to remove any dewetted lubricant layers from a magnetic recording medium in accordance with method 1500 may include an absorbent cloth configured to absorb the lubricant present in said dewetted layers and may preferably exclude abrasive materials and/or grains. Furthermore, the method 1500 includes removal of features (e.g., dewetted lubricant layers) having a height typically in the range of about 2 nm or less using the aforementioned polishing tape, whereas conventional tape burnishing processes utilize an abrasive polishing tape to remove asperities having heights in a range from about 10 nm to about 20 nm.

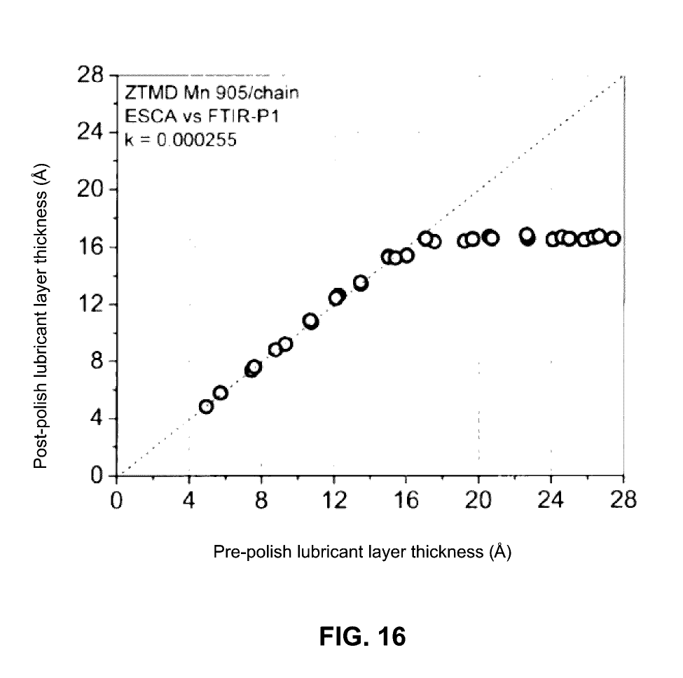

FIG. 16 provides a plot of lubricant layer thickness before and after a magnetic recording disk having a ZTMD lubricant layer thereon is polished in accordance with the method 1500. The ZTMD lubricant in this particular example comprises a plurality of ZTMD lubricants, each having a number average molecular weight, Mn, of 905/main chain. For illustration purposes only, consider a case where the initial ZTMD lubricant layer has a thickness of about 12 Å prior to implementation of the polishing process via the polishing tape. A lubricant layer thickness of 12 Å is less than the dewetting thickness of ZTMD, thus there will be no dewetting layers present on the upper surface of the magnetic recording disk. Accordingly, after implementation of the polishing process, the magnetic recording disk will still have a 12 Å thick ZTMD lubricant layer. However, once the lubricant layer thickness equals or is greater to its dewetting thickness, the linear relationship between the initial ZTMD lubricant layer thickness before the polishing process and the resulting ZTMD lubricant layer thickness after the polishing process ends (e.g., plateaus). In particular, where the initial ZTMD lubricant layer thickness on the disk is about equal to or greater than its dewetting thickness (e.g., about 16 Å or greater), implementation of the polishing process to remove any dewetted layers therefrom consistently results in a ZTMD lubricant layer having a thickness of about 16 Å, i.e., its dewetting thickness.

One exemplary approach to determine the dewetting thickness of a lubricant layer on a magnetic recording medium may thus include: (a) applying a lubricant layer having an initial thickness on a magnetic recording medium, (b) applying a polishing process, such as that embodied in method 1500 of FIG. 15, to the upper surface of the magnetic recording medium, (c) measuring the resulting lubricant layer thickness after the polishing process, and (d) comparing the initial and resulting lubricant layer thicknesses to determine if they are equal. Upon determining that the initial and resulting lubricant layer thicknesses are not equal, the initial lubricant layer thickness may be increased a predetermined amount, and steps (b) through (d) may be repeated at a predetermined time period (e.g., after each increase in initial lubricant layer thickness), until increases in initial lubricant layer thickness do not result in an increase in the resulting lubricant layer thickness as measured after the polishing process (e.g., until the resulting lubricant layer thickness remains constant regardless of increasing initial lubricant layer thickness). The lubricant layer thickness at which increases in the initial lubricant layer thickness prior to the polishing process do not result in a corresponding increase in the resulting lubricant layer thickness after the polishing process equates to the dewetting thickness of the lubricant layer.

It should be noted that methodology presented herein for at least some of the various embodiments may be implemented, in whole or in part, in computer hardware, software, by hand, using specialty equipment, etc. and combinations thereof. For instance, in particular embodiments, the methodology presented herein may be implemented, in whole or in part, in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer-executable instructions residing on a storage medium such as a physical (e.g., non-transitory) computer-readable medium. In addition, although specific embodiments of the invention may employ object-oriented software programming concepts, the invention is not so limited and is easily adapted to employ other forms of directing the operation of a computer.

In additional embodiments, the methodology presented herein may be implemented, in whole or in part, in a computer program product comprising a computer readable storage or signal medium having computer code thereon, which may be executed by a computing device (e.g., a processor) and/or system. A computer readable storage medium can include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

Further embodiments of the invention discussed herein may be implemented, in whole or in part, using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

Moreover, any of the structures and/or steps may be implemented using known materials and/or techniques, as would become apparent to one skilled in the art upon reading the present specification.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

1. A method, comprising:
forming a lubricant layer on an upper surface of a magnetic recording medium, the lubricant layer having a thickness greater than a dewetting thickness thereof; and
polishing at least a portion of the upper surface of the magnetic recording medium using a polishing tape to remove any portion of the lubricant layer that extends above the dewetting thickness thereof,
wherein, after the polishing, the resulting lubricant layer has a thickness about equal to the dewetting thickness thereof.

2. The method as recited in claim 1, wherein the lubricant layer includes at least one lubricant comprising at least one main chain segment and at least two attachment segments coupled to each main chain segment, each of the attachment segments comprising at least one functional group configured to attach to the upper surface of the magnetic recording medium.

3. The method as recited in claim 2, wherein the at least one function group is selected from a group consisting of: a hydroxyl group, a piperonyl group, an amine group, a carboxylic acid, a phosphazene group, and combinations thereof.

4. The method as recited in claim 2, wherein the at least one lubricant has a molecular weight in a range from about 1000 amu to about 6000 amu.

5. The method as recited in claim 2, wherein the at least one lubricant is selected from a group consisting of: Z-Tetraol, Z-Tetraol Multidentate (ZTMD), 24TMD, 4TMD, 2TMD, and combinations thereof.

6. The method as recited in claim 1, wherein the polishing tape comprises a cloth configured to absorb the portion of the lubricant layer that extends above the dewetting thickness thereof.

7. The method as recited in claim 1, wherein the polishing tape includes at least one of nylon, cotton, and polyester.

8. The method as recited in claim 1, wherein the polishing tape includes a nylon-based and/or polyester-based microfiber.

9. The method as recited in claim 1, wherein polishing at least a portion of the upper surface of the magnetic recording medium using the polishing tape comprises:
rotating the magnetic recording medium in a circumferential direction;
pressing the polishing tape to the upper surface of the magnetic recording medium via application of a predetermined weight load to the polishing tape; and
moving the polishing tape in a radial direction on the upper surface of the rotating magnetic recording medium.

10. The method as recited in claim 9, wherein the polishing tape is moved in a radial direction from an inner periphery of the magnetic recording medium to an outer periphery of the magnetic recording medium.

11. The method as recited in claim 9, wherein the predetermined weight load is about 20 grams.

12. The method as recited in claim 1, further comprising advancing the polishing tape to expose a new portion thereof, wherein the new portion of the polishing tape has not performed any polishing of the magnetic recording medium.

13. The method as recited in claim 12, wherein the polishing tape is advanced after an entirety of the upper surface of the magnetic recording medium has been polished.

14. A system, comprising:
a magnetic recording medium rotating in a circumferential direction thereof, the magnetic recording medium having a lubricant layer thereon;
a polishing tape;
a tape pressuring unit configured to press the polishing tape to an upper surface of the magnetic recording medium; and
at least one drive mechanism configured to move the polishing tape in a radial direction on the upper surface of the magnetic recording medium to remove any portion of the lubricant layer that extends above a dewetting thickness thereof.

15. The system as recited in claim 14, wherein the lubricant layer of the magnetic recording medium includes at least one lubricant comprising at least one main chain segment and at least two attachment segments coupled to each main chain segment, each of the attachment segments comprising at least one functional group configured to attach to the upper surface of the magnetic recording medium.

16. The system as recited in claim 15, wherein the at least one function group is selected from a group consisting of: a hydroxyl group, a piperonyl group, an amine group, a carboxylic acid, a phosphazene group, and combinations thereof.

17. The system as recited in claim 16, wherein the at least one lubricant has a molecular weight in a range from about 1000 amu to about 6000 amu.

18. The system as recited in claim 14, wherein the polishing tape comprises a cloth configured to absorb the portion of the lubricant layer that extends above the dewetting thickness thereof.

19. The system as recited in claim 14, wherein the polishing tape includes at least one of nylon, cotton, and polyester.

20. The system as recited in claim 14, wherein the polishing tape includes a nylon-based and/or polyester-based microfiber.

21. The system as recited in claim 14, wherein the at least one drive mechanism is configured to move the polishing tape in a radial direction from an inner periphery of the magnetic recording medium to an outer periphery of the magnetic recording medium.

22. The system as recited in claim 14, wherein the polishing tape is pressed to the upper surface of the magnetic recording medium under a predetermined weight load of about 100 grams.

23. The system as recited in claim 14, further comprising at least one drive mechanism configured to advance the polishing tape to expose a new portion thereof, wherein the new portion of the polishing tape has not been pressed to the upper surface of the magnetic recording medium.
